(19) United States
(12) Patent Application Publication
(10) Pub. No.: US 2026/0297356 A1
(43) Pub. Date: Oct. 1, 2026

(54) METHOD FOR FORMING SOLUTE FILM PATTERN

(71) Applicant: SEIKO EPSON CORPORATION, Tokyo (JP)

(72) Inventors: Masaya ISHIDA, HARA-MURA (JP); Toshimitsu HIRAI, HOKUTO-SHI (JP); Tatsuya FUJII, SHIOJIRI-SHI (JP); Hiroshi TAKIGUCHI, MATSUMOTO-SHI (JP)

(21) Appl. No.: 19/576,877

(22) Filed: Mar. 24, 2026

(30) Foreign Application Priority Data
Mar. 26, 2025 (JP) 2025-051233

(51) Int. Cl. C09D 11/38; B41M 7/00

(52) U.S. Cl. CPC C09D 11/38; B41M 7/00

(57) ABSTRACT

A method for forming a solute film pattern includes applying a material liquid to a medium, the material liquid containing water, a humectant having a boiling point of 180°C or higher, a solute, and an additive, the content of the humectant being 10% by mass or more and 30% by mass or less with respect to the total amount of the material liquid, reducing the atmosphere of the material liquid applied to the medium to 3000 Pa, which is the vapor pressure of water at room temperature, and reducing the above atmosphere to a pressure equal to or lower than the vapor pressure of the humectant at room temperature and maintaining the pressure for a certain period of time or longer. The humectant contains one or more of γ-butyrolactone, propylene carbonate, ethylene glycol, propylene glycol, 1,3-propanediol, 1,2-butanediol, 1,3-butanediol, dipropylene glycol, and 1,2-pentanediol.

The present application is based on, and claims priority from JP Application Serial Number 2025-051233, filed Mar. 26, 2025, the disclosure of which is hereby incorporated by reference herein in its entirety.

### BACKGROUND

### 1. Technical Field

The present disclosure relates to a method for forming a solute film pattern.

### 2. RELATED ART

In the related art, a method has been known in which a liquid is applied to a medium by an inkjet method to form a film pattern from a solute in the liquid. For example, JP-A-2003-220701 discloses an image forming method for forming a film pattern such as an image on a fabric. In addition, JP-A-2002-182028 discloses a method for manufacturing a color filter in which ink is applied to an ink receiving layer or an opening by an inkjet method to form a patterned colored portion.

JP-A-2003-220701 and JP-A-2002-182028 are examples of the related art.

However, the methods described in JP-A-2003-220701 and JP-A-2002-182028 have a problem in that it is difficult to improve ejection stability of the inkjet head during film pattern formation and film quality of a formed film pattern. Specifically, in the inkjet method, in order to stably eject a liquid such as ink, a solvent having a relatively high boiling point may be added to the ink to suppress drying of the ink in the nozzle. On the other hand, the high boiling point solvent is relatively difficult to volatilize, and may remain in the formed film pattern, thereby deteriorating film quality, such as adhesion to a base. In addition, when the volatilization of the high boiling point solvent is excessively promoted, bumping or the like may occur in the ink during the drying process, and film quality, such as smoothness, may be impaired. That is, there has been a demand for a method for forming a solute film pattern that improves ejection stability and film quality.

### SUMMARY

A method for forming a solute film pattern includes: applying a liquid to a medium by an inkjet method, the liquid containing water, a humectant having a boiling point of 180°C or higher, a solute, and an additive, the content of the humectant being 10% by mass or more and 30% by mass or less with respect to the total amount of the liquid; reducing the atmosphere of the liquid applied to the medium to 3000 Pa, which is the vapor pressure of water at room temperature; and reducing the atmosphere to a pressure equal to or lower than the vapor pressure of the humectant at room temperature and maintaining the pressure for a certain period of time or longer, wherein the humectant contains one or more of γ-butyrolactone, propylene carbonate, ethylene glycol, propylene glycol, 1,3-propanediol, 1,2-butanediol, 1,3-butanediol, dipropylene glycol, and 1,2-pentanediol.

### BRIEF DESCRIPTION OF THE DRAWINGS

FIG. 1 is a flowchart showing a method for forming a solute film pattern according to the present embodiment.

FIG. 2 is a table showing compositions and evaluation results of material liquids according to Examples and Comparative Examples.

FIG. 3 is a table showing set pressures and evaluation results in a second depressurization step according to the Examples and Comparative Examples.

FIG. 4 is a table showing the compositions and evaluation results of the material liquids according to the Examples and Comparative Examples.

FIG. 5 is a table showing the compositions and evaluation results of the material liquids according to the Examples and Comparative Examples.

FIG. 6 is a table showing the compositions and evaluation results of the material liquids according to the Examples and Comparative Examples.

### DESCRIPTION OF EMBODIMENTS

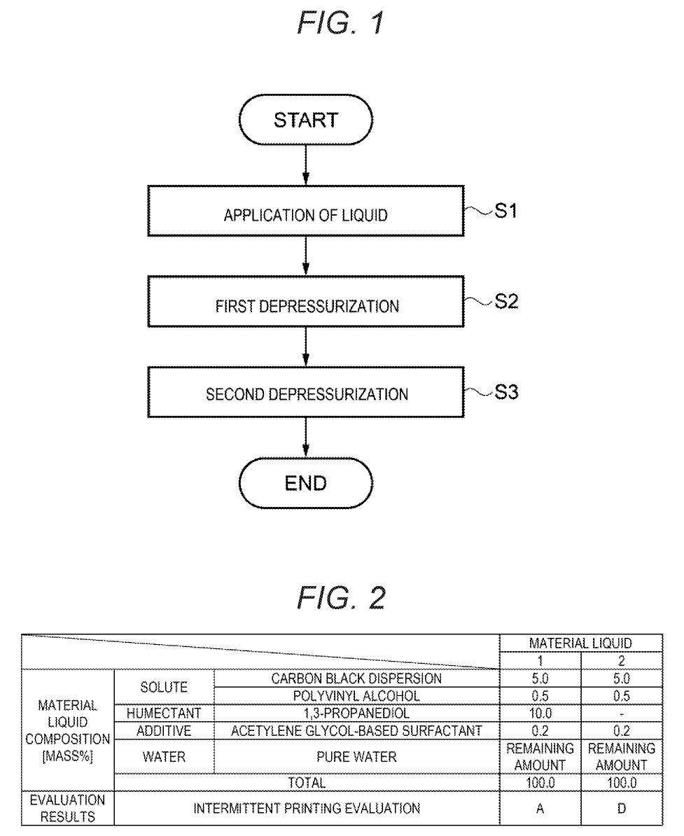

As shown in FIG. 1, the method for forming a solute film pattern according to the present embodiment includes an application step S1 of applying a liquid, a first depressurization step S2 of performing a first depressurization, and a second depressurization step S3 of performing a second depressurization. The method for forming a solute film pattern according to the present embodiment described below is an example, and is not limited thereto.

As a pre-stage of the application step S1, a liquid to be a material of a solute film pattern is prepared. The above liquid contains water, a humectant, a solute, and an additive. In the following description, the liquid serving as the material of a solute film pattern is also referred to as a material liquid. The solute film pattern is a functional film formed in a predetermined shape. Examples of the functional film include a conductive film, an insulating film, a protective film, and an optical thin film.

Water is a main solvent of the material liquid. That is, the material liquid is aqueous. Water is a component that volatilizes after the material liquid adheres to a medium to be described later. As water, it is possible to use pure water such as ion-exchanged water, ultrafiltered water, reverse osmosis water, and distilled water, and water from which ionic impurities are removed as much as possible, such as ultrapure water. In addition, when water sterilized by ultraviolet irradiation, hydrogen peroxide addition, or the like is used, generation of mold or bacteria is prevented when the material liquid is stored for a long time. The water content in the material liquid is appropriately adjusted according to the type of solute film pattern formed by the material liquid, the material of the medium, the characteristics of the inkjet head used in the application step S1, and the like.

The humectant is an organic solvent having a boiling point of 180°C or higher, and suppresses drying of the material liquid in the nozzle of the inkjet head. This improves ejection stability when the material liquid is ejected from the inkjet head in the application step S1. In addition, when the inkjet head is not used for a long period of time, clogging of the nozzle is suppressed. The term boiling point used herein refers to a normal boiling point. In the present specification, the room temperature is about 20°C to 25°C.

Specific examples of humectants include γ-butyrolactone (204°C, 150.0 Pa), propylene carbonate (242°C, 11.3 Pa), ethylene glycol (198°C, 7.0 Pa), propylene glycol (187°C, 10.7 Pa), 1,3-propanediol (214°C, 4.5 Pa), 1,2-butanediol (193°C, 10.0 Pa), 1,3-butanediol (207°C, 8.0 Pa), dipropylene glycol (231°C, 4.0 Pa), and 1,2-pentanediol (206°C, 1.5 Pa). The numerical values in parentheses following the name of each of the above organic solvents represent the boiling point (°C) and the vapor pressure (Pa) at room temperature. The material liquid contains one or more of the above organic solvents as humectants.

Since the above organic solvents have a boiling point of 180°C or higher, they are effective in suppressing drying of the material liquid in the nozzle. In addition, since the above organic solvents have relatively high solubility in water, problems such as separation of the humectant in the material liquid are less likely to occur.

Here, in a material liquid such as a conventional ink, a high boiling point compound such as glycerin or 1,5 -pentanediol may be used as a moisturizing component. Since these high boiling point compounds have a vapor pressure lower than that of the above organic solvents, there is a tendency for the compounds to be less likely to volatilize and to remain in the functional film. In contrast, the above organic solvents have a boiling point of 180°C or higher and are therefore suitable as humectants, and additionally have the characteristic of being more likely to volatilize than the above high boiling compounds.

The content of humectants in the material liquid is 10% by mass or more and 30% by mass or less, and preferably 10% by mass or more and 20% by mass or less with respect to the total amount of the material liquid. Accordingly, drying of the material liquid in the nozzle is suppressed, and remaining of the material liquid in the solute film pattern is suppressed, thereby improving film quality of the solute film pattern. In addition, an increase in viscosity of the material liquids can be suppressed due to the above organic solvent.

The solute is a component responsible for the function and characteristics of the solute film pattern. The solute is not particularly limited, and examples thereof include particles of carbon black, silica, or the like, a soluble resin such as polyvinyl alcohol, and a resin emulsion such as polyurethane. The resin functions as, for example, a binder for fixing particles such as carbon black in the solute film pattern. This makes it possible to form a solute film pattern containing particles. The content of the solute in the material liquid is appropriately adjusted according to the type of the solute film pattern formed by the material liquid, its intended use, the characteristics of an inkjet head, and the like. For example, the amount of the resin in the solute film pattern is preferably small from the viewpoint of exhibiting the inherent characteristics of the particles in the solute film pattern.

The additives are added to improve the properties of the material liquid and the characteristics of the solute film pattern. Examples of additives include surfactants, pH adjusters, and chelating agents.

The surfactants reduce the surface tension of the material liquid to improve the ejection characteristics of the material liquid from the inkjet head and the wettability of the material liquid on the medium. Examples of surfactants include an acetylene glycol-based surfactant, a silicone-based surfactant, a fluorine-based surfactant, and the like. A commercially available product may be used as the surfactant.

The content of the surfactants in the material liquid is not particularly limited, and can be set to be preferably 0.01% by mass or more and 2.00% by mass or less with respect to the total amount of the material liquid.

The pH adjusters increase the pH of the material liquid to suppress deterioration of a member such as an inkjet head. Examples of pH adjusters include inorganic bases and organic bases such as organic amine compounds. As pH adjusters, known compounds can be applied. The content of the pH adjusters in the material liquid is appropriately adjusted according to the pH of the material liquid before the pH adjusters are added.

The chelating agents form a complex of metal ions mixed in the material liquid by a chelating effect and suppress precipitation of a metal salt. This prevents the occurrence of problems such as clogging in the nozzles of the inkjet head.

Examples of the chelating agents include ethylenediaminetetraacetic acid (EDTA), sodium picolinate, potassium quinolinate, 3-hydroxy-2,2'-iminodisuccinic acid tetrasodium, methylglycinediacetic acid (MGDA), L-glutamic acid diacetic acid (GLDA), L-aspartic acid diacetic acid (ASDA), hydroxyethyliminodiacetic acid (HIDA), 3-hydroxy-2,2'-iminodisuccinic acid (HIDS), dicarboxymethylglutamic acid (CMGA), (S, S)-ethylenediaminedisuccinic acid (EDDS), and salts thereof. Examples of salts of the above chelating agents include metal salts such as sodium, potassium, and lithium, as well as salts such as ammonium and amine.

The content of the chelating agents in the material liquid is not particularly limited, and can be set to be preferably 0.01% by mass or more and 2.00% by mass or less with respect to the total amount of the material liquid.

In addition to the above-mentioned additives, the material liquid may contain various additives such as a preservative, a fungicide, and an antioxidant. Known additives can be used as these additives.

The material liquid may contain, as other components, solvents other than water and the humectants as long as film quality of the solute film pattern is not impaired. The other solvents change the drying properties of the material liquid through improvement of the solubility of the solute and correlation with the humectants and water. Examples of the other solvents include alkanediols, polyhydric alcohols, glycol ethers, and carbonate-based solvents other than those exemplified as the humectants.

In order to prepare the material liquid, the above components are mixed in any order. Thereafter, filtration and the like are performed as necessary to remove impurities, foreign substances, and the like. As a method for mixing the components, a method of adding the components to a container including a stirring device, such as a mechanical stirrer, a magnetic stirrer, or an ultrasonic stirrer, followed by stirring and mixing is used. As a filtration method, a known method such as centrifugal filtration or filter filtration can be used. The material liquid may be degassed using a vacuum pump or the like.

A numerical value of surface tension of the material liquid at 25°C is preferably 10 mN/m or more and 40 mN/m or less, and more preferably 20 mN/m or more and 40 mN/m or less. Accordingly, characteristics such as the ejection property from the inkjet head are improved. The surface tension of the material liquid can be measured using an automatic surface tensiometer CBVP-Z manufactured by Kyowa Interface Science Co., Ltd.

From the same viewpoint as the surface tension, a numerical value of viscosity of the material liquid at 20°C is preferably 2 millipascal-seconds (mPa·s) or more and 15 mPa·s or less, and more preferably 2 mPa·s or more and 5 mPa·s or less. The viscosity of the material liquid can be measured using a viscoelasticity tester MCR-300 manufactured by Pysica. Specifically, the viscosity of the material liquid at 20°C is obtained by adjusting a temperature of the material liquid to 20°C, increasing a shear rate from 10 to 1000, and reading the viscosity when the shear rate is 200.

The characteristics and characteristic values of the material liquid described above are examples, and the disclosure is not limited thereto.

In the application step S1, the material liquid is applied to the medium using the inkjet method. The inkjet method is a method of ejecting droplets of a material liquid or the like from a nozzle by utilizing a change in volume of a liquid storage chamber in an inkjet head and the like. By using the inkjet method, a relatively high-definition solute film pattern can be formed. In addition, it is easy to cope with high-mix small-volume production.

A known device such as an inkjet printer can be applied to the inkjet method. Specific examples of the inkjet printers include an on-carriage type or off-carriage type serial printer and a line-head printer.

The inkjet head includes an actuator that is a drive unit. Examples of the actuators include a piezoelectric element using deformation of a piezoelectric body, an electromechanical transducer using displacement of a diaphragm caused by electrostatic attraction, and an electrothermal transducer using bubbles generated by heating.

The medium to which the material liquid is applied is appropriately selected according to the use of the solute film pattern. Examples of the medium include an inorganic substrate made of quartz, silicon, ceramic, or the like, a film or plate made of polyvinyl chloride, polyethylene, polypropylene, and polyethylene terephthalate, a plate made of a metal or an alloy such as iron, silver, copper, and aluminum, and a fabric made of natural fibers or chemical fibers.

In the application step S1, any pattern can be formed at a surface of the medium by moving the inkjet head relative to the medium. Then, the process proceeds to the first depressurization step S2.

In the first depressurization step S2, the atmosphere of the material liquid applied to the medium is reduced to 3000 Pa, corresponding to the vapor pressure of water at room temperature. Thus, water is mainly removed from the material liquid.

Specifically, for example, the medium to which the material liquid is applied in the application step S1 is introduced into a degassing tank provided with a suction pump such as a vacuum pump. Next, the suction pump is operated to reduce the pressure in the degassing tank, that is, the pressure of the above atmosphere.

At this time, it is preferable that the valve provided in the pipe connecting the suction pump and the degassing tank is slightly throttled so as to moderate the pressure drop in the degassing tank. Water is a component that is relatively likely to volatilize in the material liquid. Therefore, by gently evaporating the component that is relatively likely to volatilize, bumping of water can be suppressed, and water can be reliably removed. By suppressing bumping of a solvent such as water, occurrence of defects such as pinholes in a solute film pattern is suppressed, and film quality such as surface smoothness and internal uniformity is improved. When the pressure in the degassing tank reaches 3000 Pa, the process proceeds to the second depressurization step S3.

In the second depressurization step S3, the atmosphere of the material liquid applied to the medium, that is, the pressure in the degassing tank, is reduced to a level equal to or lower than the vapor pressure of the humectant at room temperature. Next, the above pressure equal to or lower than the vapor pressure is maintained for a certain period of time or longer. Accordingly, the humectants are mainly removed from the material liquid. When the material liquid contains a plurality of types of humectants, the above pressure equal to or lower than the vapor pressure is set to a level equal to or lower than the vapor pressure, at room temperature, of the humectant having the lowest vapor pressure.

Specifically, in the first depressurization step S2, the medium is introduced into the degassing tank, and the above valve is fully opened with the suction pump operated, so that the pressure in the degassing tank is reduced relatively quickly. Since the humectant is unlikely to volatilize as compared with water, bumping is unlikely to occur even upon rapid depressurization under a pressure higher than its vapor pressure. When the pressure in the degassing tank falls below the above vapor pressure, a reduced pressure state equal to or lower than the above vapor pressure is maintained.

By maintaining the above reduced pressure state for a certain period of time or longer, the humectant is steadily removed. Here, the certain period of time is appropriately set according to the content of the humectants in the material liquid, the type of the humectants, the application amount of the material liquid to the medium, and the like. In addition, the above certain period of time may be set by, for example, a residual component analysis of the humectant in the formed solute film pattern. Examples of methods for analyzing the residual component include gas chromatography–mass spectrometry of gases thermally desorbed from the solute film pattern.

Here, the total time for which the pressure was reduced on the material liquid applied to the medium is preferably 20 minutes or less. In the method for forming the solute film pattern of the present embodiment, as described above, solvents such as water and humectants are likely to be removed while suppressing the occurrence of bumping. Therefore, in the first depressurization step S2 and the second depressurization step S3, the total time during which the material liquid applied to the medium is kept under reduced pressure may be shortened to 20 minutes or less while ensuring film quality. Thus, the time required for forming the solute film pattern can be shortened.

The material liquid applied to the medium is preferably not subjected to a heat treatment at 30°C or higher. In the method for forming the solute film pattern of the present embodiment, as described above, solvents such as water and humectants are likely to be removed, and the heat treatment can be omitted. As a result, it is possible to suppress the deterioration of the solute film pattern and the change in characteristics due to the thermal history.

After the second depressurization step S3 is completed, the inside of the degassing tank is returned to the atmospheric pressure by an atmosphere opening valve or the like. Thus, a solute film pattern is formed at the medium.

According to the embodiment, the following effects can be obtained.

The ejection stability and film quality of the solute film pattern can be improved. Specifically, since the content of the humectants is 10% by mass or more, in the application step S1, drying of the material liquid in the nozzle of the inkjet head is suppressed, and the ejection stability is improved. In addition, since the content of the humectants is 30% by mass or less, the humectants are less likely to remain in the solute film pattern, and the film quality, such as adhesion of the solute film pattern to the base, is improved.

After water is volatilized in the first depressurization step S2, the pressure is reduced to a pressure equal to or lower than the vapor pressure of the humectant in the second depressurization step S3 and is maintained for a certain period of time or longer, thereby allowing the humectant to be more likely volatilized. In addition, occurrence of bumping in the material liquid in the drying process is suppressed, and film quality such as smoothness of the solute film pattern is improved.

Since the humectants are the above organic solvents, the solubility of the humectants in water is improved, and problems such as separation of the humectants are less likely to occur. In addition, since the vapor pressures of the above organic solvents are sufficiently lower than the vapor pressure of water, drying of the material liquid in the nozzle is further suppressed. As described above, a method for forming a solute film pattern that improves ejection stability and film quality can be provided.

Hereinafter, the effects of the embodiment will be described in more detail with reference to Examples and Comparative Examples. In FIGS. 2 and 4 to 6, notation of "-" in a composition column of the material liquid means that a component is not contained. In addition, the numerical values in the composition columns of the carbon black dispersion and the silica dispersion described later are expressed in terms of solid content.

Each component was mixed and stirred in the composition of a material liquid 1 shown in FIG. 2. The material liquid 1 contains 10.0 mass% of 1,3-propane diol as a humectant. Specifically, Aqua-Black (registered trademark) 162 manufactured by Tokai Carbon Co., Ltd. was used as the carbon black dispersion. An Olefin E series manufactured by Nissin Chemical Industry Co., Ltd. was used as the acetylene glycol-based surfactant. As polyvinyl alcohol, polyvinyl alcohol 2000 manufactured by Kanto Chemical Co., Inc. was used. Since the polyvinyl alcohol requires time to dissolve, a 10% by mass aqueous solution was prepared in advance, and a predetermined amount was added in the form of the solution. Each component was weighed and introduced into a glass beaker, subjected to ultrasonic treatment at room temperature for about 5 minutes, and mixed sufficiently to prepare the material liquid 1.

In addition, as a comparative example, a material liquid 2 was prepared by omitting 1,3-propanediol as the humectant from the material liquid 1. The material liquid 2 has a composition in which 1,3-propanediol contained in the material liquid 1 is replaced with pure water. Except for the difference in the above components, the material liquid 2 of the comparative example was prepared in the same manner as the material liquid 1.

Next, an intermittent printing evaluation, which is an index of ejection stability of the inkjet head, was performed for the material liquid 1 and the material liquid 2. Specifically, the material liquid 1 was introduced into an ink container, and then, through a tube, the material liquid 1 was filled from the ink container to an inkjet head S800 manufactured by Seiko Epson Corporation. Thereafter, a nozzle check was performed by printing a nozzle check pattern with the above inkjet head, and it was confirmed that all the nozzles normally ejected the material liquid 1.

Next, the standing time between the nozzle check and the subsequent printing of the nozzle check pattern was varied, the ejection state of each nozzle was investigated, and ejection stability was evaluated according to the following criteria.

### Evaluation Criteria

A: All nozzles eject ink normally even when left for 3 minutes.
B: When left for 2 minutes, all nozzles eject ink normally, but when left for 3 minutes, ejection failure occurs.
C: When left for 1 minute, all nozzles eject ink normally, but when left for 2 minutes, ejection failure occurs.
D: Ejection failure occurs even after leaving for 1 minute.

For the material liquid 2 as well, the ejection state of each nozzle was investigated in the same manner as for the material liquid 1 while varying the standing time, and the ejection stability was evaluated according to the above evaluation criteria.

From the results of the intermittent printing evaluation, it was shown that in the material liquid 1, drying of the liquid surface in the nozzle of the inkjet head was suppressed, leading to improved ejection stability. In contrast, in the material liquid 2 of Comparative Example, it was found that the liquid surface in the nozzle was likely to dry, and the ejection stability was unlikely to improve.

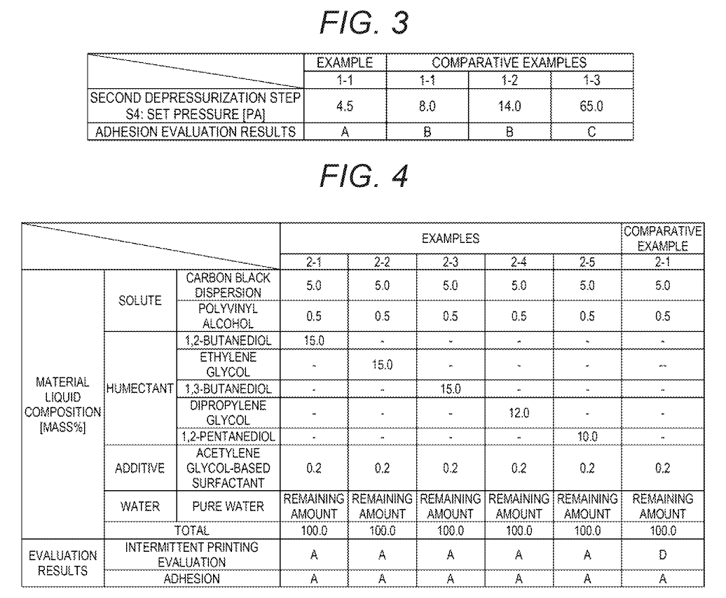

As shown in FIG. 3, the film quality of the solute film pattern was evaluated after the solute film pattern was formed by varying the pressure in the degassing tank in the second depressurization step S3 for the material liquid 1. Specifically, first, as described above, the material liquid 1 was filled in the inkjet head, and it was confirmed that all the nozzles normally ejected. Thereafter, as the application step S1, the material liquid 1 was printed in two overlapping layers on the medium in a solid pattern of 90 mm square under conditions of a resolution of 1200 × 1200 dots per inch (dpi) and a droplet volume of 10 pL (picoliters). A glass substrate and a polyethylene terephthalate film were used as the above medium.

Next, as the first depressurization step S2, each medium immediately after printing was introduced into a vacuum drying chamber, and the chamber pressure was reduced from atmospheric pressure to 3000 Pa in 5 minutes by means of a scroll pump.

Next, as the second depressurization step S3, in Example 1-1, the pressure in the chamber was reduced from 3000 Pa to 4.5 Pa, which is the vapor pressure of 1,3-propanediol at room temperature, in 6 minutes. Here, in the second depressurization step S3, the target pressure to be reduced from 3000 Pa is referred to as the set pressure.

After the pressure in the chamber reached the set pressure, the humectant was continuously removed for 6 minutes in a state where the pressure was reduced to the set pressure of 80% or less. The pressure in the chamber was adjusted by adjusting the opening degree of the exhaust valve of the vacuum drying chamber. Thereafter, the scroll pump was stopped, the exhaust valve was opened to return the pressure in the chamber to the atmospheric pressure, and then each medium on which the solute film pattern of Example 1-1 was formed was taken out. The thickness of the solute film pattern of Example 1-1 formed at each medium was about 0.9 μm. In Example 1-1, the total time for which the pressure was reduced was about 17 minutes, and the solute film pattern could be formed in a relatively short time.

In Comparative Example 1-1, the solute film pattern of Comparative Example 1-1 was formed at each medium in the same manner as in Example 1-1 except that the set pressure was 8.0 Pa. In Comparative Example 1-2, the solute film pattern of Comparative Example 1-2 was formed at each medium in the same manner as in Example 1-1 except that the set pressure was 14.0 Pa. In Comparative Example 1-3, the solute film pattern of Comparative Example 1-3 was formed at each medium in the same manner as in Example 1-1 except that the set pressure was 65.0 Pa. The thickness of each solute film pattern of Comparative Examples 1-1, 1-2, 1-3 was about 0.9 μm.

Next, as an index of film quality, the conductivity of the solute film patterns at each level was measured, and no difference in conductivity was observed between the Examples and Comparative Examples.

Next, as an index of film quality, the adhesion of the solute film patterns at each level was evaluated by the cross-cut method. Specifically, the evaluation was conducted in accordance with JIS K 5600-5-6:1999, Testing methods for paints: Mechanical properties of films: Adhesion (cross-cut test). The appearance of the cross-cut portion after tape peeling was observed and classified, and the adhesion was evaluated according to the following evaluation criteria. In each level of the Examples and Comparative Examples, no difference was observed in the adhesion evaluation results with respect to the medium.

### Evaluation Criteria

A: The classification of the test result is 0 (the edges of the cuts are smooth, and no peeling is observed in any of the grids).
B: The classification of the test result is 1.
C: The classification of the test result is 2.
D: The classification of the test result is 3.
C: The classification of the test result is 4.
D: The classification of the test result is 5 (severe peeling that cannot be classified as grade 4).

From the adhesion evaluation results, it was shown that in Example 1-1, the humectant was reliably removed, resulting in improved adhesion. In contrast, in all the Comparative Examples, the humectant was presumed to remain, and adhesion was unlikely to be improved.

As shown in FIG. 4, the material liquids prepared by changing the type of the humectant were subjected to the intermittent printing evaluation, and adhesion of the solute film patterns formed from each material liquid was evaluated. First, the material liquids at each level were prepared.

Specifically, in the material liquid of Example 2-1, the humectant was replaced with 1,2-butanediol, the content was 15.0 mass%, and the content of pure water was reduced by 5.0 mass% with respect to the above material liquid 1. Except for these, the material liquid of Example 2-1 was prepared in the same manner as in the material liquid 1.

In the material liquid of Example 2-2, the material liquid of Example 2-2 was prepared in the same manner as the material liquid of Example 2-1 except that the humectant was replaced with ethylene glycol.

In the material liquid of Example 2-3, the material liquid of Example 2-3 was prepared in the same manner as the material liquid of Example 2-1 except that the humectant was replaced with 1,3-butanediol.

In the material liquid of Example 2-4, the humectant was replaced with dipropylene glycol, and the content of dipropylene glycol was set to 12.0% by mass with respect to the material liquid of Example 2-1. The content of pure water was increased by 3.0 mass%. Except for these, the material liquid of Example 2-4 was prepared in the same manner as the material liquid of Example 2-1.

In the material liquid of Example 2-5, the humectant was replaced with 1,2-pentanediol, and the content of 1,2-pentanediol was set to 10.0 mass% with respect to the material liquid of Example 2-1. The content of pure water was increased by 5.0 mass%. Except for these, the material liquid of Example 2-5 was prepared in the same manner as the material liquid of Example 2-1.

In the material liquid of Comparative Example 2-1, the humectant was omitted and the content of pure water was increased by 15.0 mass% with respect to the material liquid of Example 2-1. Except for this, the material liquid of Comparative Example 2-1 was prepared in the same manner as the material liquid of Example 2-1.

Next, the intermittent printing evaluation was performed in the same manner as in the above material liquid 1, and the evaluation results are shown in FIG. 4. From the results of the intermittent printing evaluation, it was shown that in the material liquids of Examples 2-1 to 2-5, drying of the liquid surface in the nozzle of the inkjet head was suppressed, and the ejection stability was improved. In contrast, in the material liquid of Comparative Example 2-1, it was found that drying of the liquid surface in the nozzle was likely to proceed, and the ejection stability was unlikely to be improved.

Next, solute film patterns were formed at each level in the same manner as in the above Example 1-1, adhesion was evaluated, and the results are shown in FIG. 4. In each level, the set pressure at the time of forming the solute film pattern was the vapor pressure at room temperature of the humectant contained in each level. Since the material liquid of Comparative Example 2-1 did not contain a humectant, the set pressure was set to 100 Pa. The thickness of the solute film patterns was about 0.9 μm for all levels.

From the adhesion evaluation results, it was shown that in Examples 2-1 to 2-5, the humectants were reliably removed, resulting in improved adhesion. In addition, in Comparative Example 2-1, it was found that the adhesion was improved because the humectant was not originally contained.

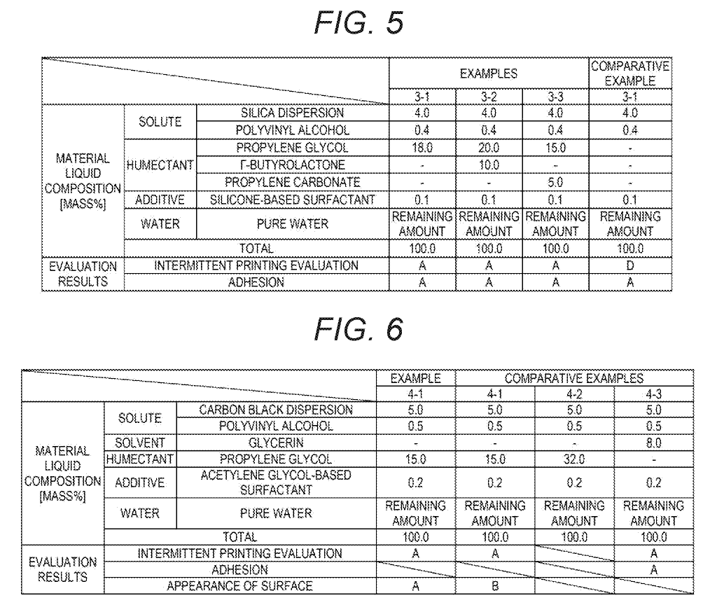

Each component was mixed and stirred in the composition of the material liquids at each level shown in FIG. 5. The material liquid of Example 3-1 contained 18.0% by mass of propylene glycol as a humectant. Specifically, as a silica dispersion liquid, SNOWTEX (registered trademark) C type (particle diameter: 5 nm) manufactured by Nissan Chemical Corporation was used, and the silica content was set at 4.0% by mass. The content of polyvinyl alcohol was changed to 0.4 mass% with respect to the material liquid 1. Silface (registered trademark) SAG503A manufactured by Nissin Chemical Industry Co., Ltd. was used as the silicone-based surfactant. Then, the amount of change in each content was adjusted by the content of pure water. Except for these, the material liquid of Example 3-1 was prepared in the same manner as the above material liquid 1.

The material liquid of Example 3-2 is different from the material liquid of Example 3-1 in that two types of humectants were used in combination. Specifically, the material liquid of Example 3-2 contains 20% by mass of propylene glycol and 10% by mass of γ-butyrolactone as humectants, and the content of pure water is 12% by mass less than that of the material liquid of Example 3-1. Except for these, the material liquid of Example 3-2 was prepared in the same manner as the material liquid of Example 3-1.

The material liquid of Example 3-3 is also different from the material liquid of Example 3-1 in that two types of humectants were used in combination. Specifically, the material liquid of Example 3-3 contains 15% by mass of propylene glycol and 5% by mass of propylene carbonate as humectants, and the content of pure water is 2% by mass less than that of the material liquid of Example 3-1. Except for these, the material liquid of Example 3-3 was prepared in the same manner as the material liquid of Example 3-1.

In the material liquid of Comparative Example 3-1, the humectant was omitted and the content of pure water was increased by 18.0 mass% with respect to the material liquid of Example 3-1. Except for these, the material liquid of Comparative Example 3-1 was prepared in the same manner as the material liquid of Example 3-1.

Next, the material liquids at each level were subjected to the intermittent printing evaluation in the same manner as in the above material liquid 1, and the evaluation results are shown in FIG. 5. From the results of the intermittent printing evaluation, it was shown that in the material liquids of Examples 3-1, 3-2, 3-3, drying of the liquid surface in the nozzle of the inkjet head was suppressed, and the ejection stability was improved. Accordingly, it was shown that the moisturizing effect was obtained even when different humectants were used in combination. In contrast, in the material liquid of Comparative Example 3-1, it was found that the liquid surface in the nozzle was likely to dry, and the ejection stability was unlikely to improve.

Next, solute film patterns were formed for the material liquids at each level, and the film quality was evaluated. Specifically, the set pressure was 10.7 Pa, and in the second depressurization step S3, the pressure was reduced from 3000 Pa to the set pressure with a depressurization time of 5 minutes, and then a state in which the pressure was reduced to 80% of the set pressure was maintained for 5 minutes. Except for these, the solute film patterns at each level were formed in the same manner as in Example 1-1. The material liquid of Comparative Example 3-1 did not contain a humectant, but the above conditions were matched with Example 3-1. The thickness of the formed solute film patterns was about 0.7 μm for all levels.

Next, the adhesion of each solute film pattern was evaluated in the same manner as in Example 1-1, and the results are shown in FIG. 5. From the adhesion evaluation results, it was shown that in Examples 3-1, 3-2, 3-3, the humectants were reliably removed, resulting in improved adhesion. In addition, in Comparative Example 3-1, it was found that the adhesion was improved because the humectant was not originally contained.

Each component was mixed and stirred in the composition of the material liquids at each level shown in FIG. 6. In the material liquid of Example 4-1, the humectant was replaced with propylene glycol with respect to the material liquid of the above Example 2-1. Except for these, the material liquid of Example 4-1 was prepared in the same manner as the material liquid of Example 2-1.

The material liquid of Comparative Example 4-1 had the same composition as the material liquid of Example 4-1. In the material liquid of Comparative Example 4-2, the content of propylene glycol was increased to 32 mass% and the content of pure water was reduced by 17 mass% with respect to the material liquid of Example 4-1. Except for these, the material liquid of Comparative Example 4-2 was prepared in the same manner as the material liquid of Example 4-1. In the material liquid of Comparative Example 4-3, glycerin was used in place of propylene glycol, the content of glycerin was set to 8 mass%, and the content of pure water was increased by 7 mass% with respect to the material liquid of Example 4-1. Except for these, the material liquid of Comparative Example 4-3 was prepared in the same manner as the material liquid of Example 4-1.

Next, the material liquids at each level were subjected to the intermittent printing evaluation in the same manner as in the above material liquid 1, and the evaluation results are shown in FIG. 6. From the results of the intermittent printing evaluation, it was shown that in the material liquids of Examples 4-1 and Comparative Examples 4-1, 4-3, drying of the liquid surface in the nozzle of the inkjet head was suppressed, and the ejection stability was improved. In contrast, in the material liquid of Comparative Example 4-2, the ejection was unstable from the initial stage, and the nozzle check pattern could not be printed. This is presumed to be due to an increase in the viscosity of the material liquid at room temperature to about 56 mPa·s as a result of increasing the amount of propylene glycol to 32 mass%.

Next, solute film patterns were formed for the material liquids at each level, and the film quality was evaluated. Specifically, in Example 4-1, with respect to Example 1-1, the set pressure was 10.7 Pa, and in the second depressurization step S3, the pressure was reduced from 3000 Pa to the set pressure with a depressurization time of 5 minutes, and then a state in which the pressure was reduced to 80% of the set pressure was maintained for 5 minutes. Except for these, the solute film pattern of Example 4-1 was formed in the same manner as in Example 1-1.

In Comparative Example 4-1, with respect to Example 4-1, the first depressurization step S2 was omitted, and the pressure in the vacuum drying chamber was reduced from the atmospheric pressure to the set pressure of 10.7 Pa at once in 6 minutes. Thereafter, a state in which the pressure was reduced to 80% of the set pressure was maintained for 5 minutes. Except for these, the solute film pattern of Comparative Example 4-1 was formed in the same manner as in Example 4-1.

In Comparative Example 4-2, since the ejection of the material liquid was unstable, the formation of the solute film pattern was omitted.

In Comparative Example 4-3, the set pressure was set to 0.01 Pa, corresponding to the vapor pressure of glycerin at room temperature. In the first depressurization step S2, the pressure was reduced from the atmospheric pressure to 3000 Pa in 5 minutes. In the second depressurization step S3, the pressure was reduced from 3000 Pa to 0.01 Pa in 15 minutes, and then a state in which the pressure was reduced to 80% of the set pressure was maintained for 8 minutes. In Comparative Example 4-3, the total time for which the pressure was reduced, corresponding to the total time of the first depressurization step S2 and the second depressurization step S3, was 28 minutes.

Except for these, the solute film pattern of Comparative Example 4-3 was formed in the same manner as in Example 4-1. The thickness of the formed solute film pattern of Comparative Example 4-3 was about 0.9 μm. In Comparative Example 4-3, since a high degree of pressure reduction was required, a turbo molecular pump was used in addition to the scroll pump.

For the solute film patterns of Example 4-1 and Comparative Example 4-1, the surfaces were observed with an optical microscope, and the appearance of the surfaces, representing the film quality, was evaluated according to the following evaluation criteria.

### Evaluation Criteria

A: No pinholes or remarkable irregularities are observed, and the film is determined as a smooth membrane.

B: Localized irregularities and non-uniformity of the film are observed.

As a result of evaluating the appearance of the surface, it was shown that a solute film pattern having a good surface was obtained in Example 4-1. In contrast, in Comparative Example 4-1, it was found that it was difficult to improve the appearance of the surface.

The solute film pattern of Comparative Example 4-3 was evaluated for adhesion in the same manner as in the above Example 1-1, and the evaluation results are shown in FIG. 6. From the above evaluation results, it was shown that the adhesion was improved in Comparative Example 4-3. However, in addition to the fact that a relatively long total time of 28 minutes was required for the pressure to be reduced, the use of a turbomolecular pump was required.

What is claimed is:

1. A method for forming a solute film pattern comprising: applying a liquid to a medium by an inkjet method, the liquid containing water, a humectant having a boiling point of 180°C or higher, a solute, and an additive, the content of the humectant being 10% by mass or more and 30% by mass or less with respect to the total amount of the liquid;
reducing the atmosphere of the liquid applied to the medium to 3000 Pa, which is the vapor pressure of water at room temperature; and
reducing the atmosphere to a pressure equal to or lower than the vapor pressure of the humectant at the room temperature and maintaining the pressure for a certain period of time or longer,
wherein the humectant contains one or more of γ-butyrolactone, propylene carbonate, ethylene glycol, propylene glycol, 1,3-propanediol, 1,2-butanediol, 1,3-butanediol, dipropylene glycol, and 1,2-pentanediol.

2. The method for forming a solute film pattern according to claim 1, wherein the liquid applied to the medium is not subjected to heat treatment at 30°C or higher.

3. The method for forming a solute film pattern according to claim 1, wherein the total time for which pressure is reduced on the liquid applied to the medium is 20 minutes or less.
